(19) United States
(12) Patent Application Publication
(10) Pub. No.: US 2014/0278657 A1
(43) Pub. Date: Sep. 18, 2014

(54) HIRING, ROUTING, FUSING AND PAYING FOR CROWDSOURCING CONTRIBUTIONS

(71) Applicant: MICROSOFT CORPORATION, (US)

(72) Inventors: Eric J. Horvitz, Kirkland, WA (US); Semiha E. Kamar Eden, Kirkland, WA (US)

(73) Assignee: MICROSOFT CORPORATION, Redmond, WA (US)

(21) Appl. No.: 13/843,293

(22) Filed: Mar. 15, 2013

(51) Int. Cl. G06Q 10/06

(52) U.S. Cl. CPC G06Q 10/063118
USPC 705/7.17

(57) ABSTRACT

The subject disclosure is directed towards using one or more machines with respect intelligently performing a task, such as a crowdsourcing task. Prediction models are used to determine how many workers are needed for a task, based upon a budget and a general goal of trying to use as few workers as needed to achieve a desired result. A number of workers needed to perform a task, without exceeding a budget is computed by predicting future contributions to estimate the number of workers. Also described is predicting based upon existing data, predicting when there is no existing data with which to start based upon adapting, and fairer payment schemes.

### BACKGROUND

Crowdsourcing generally refers to solving tasks via a large scale community (the “crowd”), relying on people who work remotely and independently via the Internet. Crowdsourcing is based upon the idea that large numbers of individuals often act more effectively and accurately than even the best individual (e.g., an “expert”).

Crowdsourcing tasks are generally computer-based digital tasks, examples of which include text editing, image labeling, speech transcription, language translation, software development, and providing new forms of accessibility for the disabled. Such tasks are intellectual tasks that are accomplished remotely over the Internet, in which workers are generally engaged to participate in task completion independently of one another, often in exchange for compensation or some other reward.

To the extent computers are involved in crowdsourcing tasks, computers have been employed largely in the role of platforms for recruiting and reimbursing human workers. The rest of the management of crowdsourcing, such as making hiring decisions and incentivizing workers properly, has relied on manual designs and controls. This time consuming job is a barrier for wider use of crowdsourcing.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards handling a task including using prediction models to determine whether/how many workers are needed for the task. In one aspect, a task including task data comprising a budget is received. A number of workers needed to perform the task, either without exceeding the budget or in a way that maximizes overall utility, is computed, including by predicting future contributions using one or more answer models to estimate the number of workers. Also described is predicting based upon existing data, predicting when there is no existing data with which to start based upon adapting, and fairer payment schemes.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram including components configured to handle tasks with respect to deciding workers to work on the task based upon predictive models, according to one example embodiment.

FIG. 2 is a flow diagram showing example steps related to handling a task, including performing decision making with respect to hiring workers, according to one example embodiment.

FIGS. 3A and 3B are representations of search trees generated with high and low uncertainty over models, respectively, according to one example embodiment.

FIG. 4 is a block diagram representing an example computing environment, into which aspects of the subject matter described herein may be incorporated.

### DETAILED DESCRIPTION

Various aspects described herein are directed towards algorithms for constructing crowdsourcing systems in which computer agents learn about tasks and about the competencies of workers contributing to solving the tasks, and make effective decisions for guiding and fusing multiple contributions. To this end, the complementary strengths of humans and computer agents are used to solve crowdsourcing tasks more efficiently.

It should be understood that any of the examples herein are non-limiting. For example, crowdsourcing tasks used as examples herein are only non-limiting examples, and numerous other tasks may similarly benefit. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and crowdsourcing in general.

Described is a framework, sometimes referred to as a CrowdSynth framework, that is configured designed for effectively solving classes of crowdsourcing tasks including consensus tasks, discovery tasks and iterative refinement tasks. A crowdsourcing task is classified as a consensus task if it centers on identifying a correct answer that is not known to the task owner and there exists a population of workers that can make predictions about the correct answer. A large percentage of tasks that are being solved on popular crowdsourcing platforms today can be classified as consensus tasks. A discovery task is an open-ended task that does not have a definite correct answer. For example, a discovery task may ask the crowd to describe an image, or label interesting parts of the image, so that the task owner can discover things about the image. An iterative refinement task is a building type of task. For example, one set of workers may work on a paragraph, and then pass that paragraph to other workers to refine and/or edit the earlier work.

While most of the examples herein are directed towards consensus tasks, which is a large class of crowdsourcing, it is understood that any type of crowdsourcing tasks including discovery tasks and iterative refinement tasks may benefit from the technology described herein.

Thus, a consensus task centers on identifying a correct answer that is unknown to the task owner but can be correctly identified by aggregating multiple workers' predictions. Formally, a consensus task t is characterized as follows: Let A be the set of possible answers for t. There exists a mapping t→āεA that assigns each task to a correct answer. L⊂A is a subset of answers that workers are aware of, oεL is the prediction (vote) of a worker about the correct answer of the task. Each task is associated with a finite horizon (budget) h that determines the maximum number of workers that can be hired for a task. The task owner has a positive utility uεR>0 for correctly identifying the correct answer of the task, but hiring each worker is associated with a cost cεR>0. Once the budget is consumed, a consensus rule f maps the sequence of worker votes {o₁, . . . , oₕ} to the correct answer a*εA. A widely used example of consensus rule is the majority rule, which determines the correct answer as the answer that is predicted the most by the workers.

Consensus tasks are generally difficult to automate with high accuracy, but are easy for people to infer the correct answer. Efforts for solving consensus tasks with crowdsourcing have focused on collecting multiple noisy inferences from workers and seeking their consensus.

FIG. 1 is a block diagram showing example components and flow of analysis of the CrowdSynth framework 102. The framework 102 takes as input a consensus task, e.g., into a decision making component 104. In general, the decision making component processes preferences and other properties associated with the task, such as answer quality, value of answers of different qualities, deadlines, and cost, e.g., per person and a total budget.

The framework 102 has access to a worker pool 106 comprising a population of workers who are able to report their (noisy) inferences about the correct answer. Given that L⊂A is a subset of answers of which the system and workers are aware, a report of a worker includes the worker's vote, vεL, which is the worker's prediction of the correct answer.

As described herein, the system can hire a worker at any time or may decide to terminate the task with a prediction about the correct answer of the task based on reports collected so far (â). A general goal of the system is to accurately predict the correct answer of a given task based on potentially noisy worker reports, while also considering the cost of resources (by collecting as few reports from workers as possible). A successful system for solving consensus tasks thus needs to manage the trade-off between making more accurate predictions about the correct answer by hiring more workers, and the time and monetary costs for hiring.

As described herein, the system may perform this tradeoff analysis by employing machine learning and decision-theoretic planning techniques in synergy. The system monitors the worker population and task execution, and collects data about task properties, votes collected for tasks and worker statistics. Historical data collected about tasks and workers are stored in databases, and used to train predictive models for tasks and workers. In addition to learning from past tasks and past interactions of the system with workers, the system includes components for performing automated task analysis.

The system uses machine learning to fuse worker inputs for a task with historical evidence and automated task analysis to make accurate inference about the correct answer of tasks and to predict worker behavior.

A feature generation component (e.g., part of or coupled to the decision component 104) is connected to task and worker databases 109, 110, respectively, and automated task analysis (in the decision component) to generate a set of features that describe the properties of a task, worker votes collected for the task, the properties of the workers reported for the task, and reasoning performed for the task with automated machine analysis. The set of features generated for a task is provided to the modeling component as input to enable learning and inference.

The answer and vote prediction models 112, 114, respectively, are constructed with supervised learning. Log data of any system for solving consensus tasks provides labeled examples of workers' votes for tasks. Labeled examples for training answer models may be obtained from experts who identify the correct answer of a task with high accuracy. When expert opinion is not available, the consensus system may assume that the answer deduced from the reports of “infinitely” many workers according to a predetermined consensus rule is the correct answer of a given task (e.g., the majority opinion of infinitely many workers). The tasks that do not converge on a consensus answer after “infinitely” many workers' votes are assigned undecidable as the correct answer. When the system may have undecidable tasks as inputs, the set of all possible answers is defined as A=L∪{undecidable}. In practice, labels for training answer models are determined using the consensus rule after collecting many (approximately infinite) number of worker reports. To train answer models without experts, the system collects many worker reports for each task in the training set, deduces the correct answer for each task, and records either the consensus answer or the undecidable label.

A decision-theoretic planner component (shown as the VOI calculation) 118 uses the inferences performed by answer and vote models to optimize hiring decisions. To analyze the trade-off between hiring an additional worker versus terminating the task immediately, the system reasons about the confidence of the system about its inference of the correct answer, whether this confidence will likely to change in the future if the system hires more workers, and the cost associated with hiring additional workers. The planner makes use of answer models for estimating the confidence on the prediction so that the planning component can decide whether to hire an additional worker. Vote models constitute the stochastic transition functions used in planning for predicting the future states of the model.

The decision-theoretic planner models consensus tasks as Markov Decision Processes (MDP) with partial observability. The MDP model is able to represent both the system's uncertainty about the correct answer and uncertainty about the next vote that would be received from workers. The planner computes the expected value of information (VOI) that would come with the hiring of an additional worker and determines whether the system should continue hiring (H) or terminate ( [symbol] H) at any given state to maximize the total utility of the system. The utility is a combination of the reward (or punishment) of the system for making a correct (or incorrect) prediction and cost for hiring a worker. If the planner determines that hiring an additional worker (H) is the best action to take, the system accesses to the worker pool to obtain an additional worker report. After receiving the additional report, the system updates its predictions of the correct answer with the new evidence and reruns the planner to determine the next best action to take. If the planner chooses to terminate the task, the CrowdSynth framework delivers the most likely inferred answer to the task owner.

A modeling component is responsible for constructing two groups of predictive models, namely answer models for predicting the correct answer of a given consensus task, and vote models that predict the next state of the system by predicting the votes that the system would receive from additional workers should they be hired, based on the current information state. The answer models are used to generate a prediction of the correct answer of a system continuously at any point during execution, and also used to assess the system's confidence on prediction of the correct answer. The models fuse together worker input with historical evidence collected for tasks and workers and with evidence automatically generated with task analysis. The vote models are used to predict the future to see how the system's prediction of the correct answer is likely to evolve in the future if the system decides to hire more workers. The way that these models are generated and the way they enable the optimization of hiring decisions are described below.

The CrowdSynth framework 102 monitors task execution and collects log data, which includes the votes collected for different tasks and statistics about worker behavior. The framework uses the log data to learn models for predicting the correct answer of a task and for predicting worker behavior. Each log entry in the dataset corresponds to a worker report collected for a subtask, e.g., identifying an object. The entry includes the identification number of the object, the identifier for the worker, the vote of the worker for the object (vᵢεL), and statistics (fₛᵢ) about the worker reporting vᵢ. The vote of the worker represents the worker's prediction of the correct answer. Worker statistics include the dwell time of the worker, and the time and day the report is received.

A feature generation function F has access to the worker and task databases and the automated task analysis. Given the features of a task fₜ, and a history of worker reports collected so far, (hₜ={<v₁, fₛ₁>, . . . , <vₜ, fₛₜ>}), the function F generates sets of features that summarize task characteristics, the votes collected for a task, and the characteristics of the workers reported for the task.

The set of features f for one such task is composed of four main sets of features: fₜ, task features, fᵥ, vote features, f_{w}, worker features, and f_{v-w}, vote-worker features. Task features may be extracted with automated task analysis. These features are available for each classification type in the system in advance of votes from workers. For example, if classifying a galaxy, for each celestial body image input to the system, the features may describe the brightness of the image, the amount of noise inherent in the image, and photometric properties of the object in the image, and include automatically generated deductions about the morphological classification of the image. These features help the predictive models identify which images are hard for people to classify (e.g., noise in the images), and they also offer additional evidence about the true classification about the object (e.g., morphological classification).

Vote features capture statistics about the votes collected by the system at different points in the completion of tasks. These features include the number of votes collected, the number and ratio of votes for each class in L, the entropy of the vote distribution, and the majority class, the difference between the number of votes for the majority class and the next most populated class, and ratio of votes for the majority class. These features offer evidence about the agreement among workers and help to predict whether consensus is likely to be reached. For example, having a peaked distribution for a particular object after collecting a large number of votes may indicate that the object is likely to be decidable on the majority class.

Worker features include attributes that represent multiple aspects of the current and past performance, behaviors, and experience of workers contributing to the current task. A training set stored in the worker database 110 calculates features about a worker's past performance. These features may include the average dwell time of workers on previous tasks, average dwell time for the current task, their difference, mean and variance of number of tasks completed in past, and average worker accuracy on aligning with the correct answer. These features distinguish whether the workers reporting for a task are highly accurate and experienced so that the models can adjust how much to trust the votes obtained from workers; payment may be conditioned on skill level. The time that workers spend for different tasks may also serve as evidence for how difficult different tasks are.

Vote-worker features comprise statistics that combine vote distributions with worker statistics. These include such attributes as the vote by the most experienced worker among the workers who voted in the task, the level of experience of that worker, the vote of the most accurate worker, and the accuracy of that worker.

Bayesian structure learning from the case library is used to build probabilistic models that make predictions about consensus tasks. For any given learning problem, the learning algorithm selects the best predictive model by performing heuristic search over feasible probabilistic dependency models guided by a Bayesian scoring rule. A variant learning procedure that generates decision trees for making predictions may be used.

The weight of the information provided by different feature sets changes as more worker reports are collected for a consensus task. For example, vote features are not much descriptive when the system has a few votes, but they become strong indicators of the correct answer when many votes are collected. To simplify the learning tasks, individual predictive models may be built for making predictions at different time steps when varying number of worker reports are available (e.g., separate predictive models are trained for cases when the system has less reports than when it has more reports.).

Turning to predicting the correct answer of a consensus task based on noisy reports collected from workers and features describing the task and workers, the answer prediction model 112 determines the final answer that will be the output of the system. The model assesses the confidence with the current prediction to guide future hiring decisions. The answer prediction problem may be modeled as a supervised learning problem. To generate labeled examples for a set of tasks, a consensus rule that is identified by the designers of the task system is used, after a thorough analysis of the dataset. For example, after hiring as many workers as possible for identifying an object within a budget, (e.g., a minimum of ten reports), if at least some task-specified percentage of the workers (e.g., eighty percent) agree on a classification for that object, that classification is assigned to the object as the correct answer.

Not all objects in a dataset have votes with sufficient agreement on a classification when all votes for that object are collected. Such objects are classified as “undecidable”—define A=L∪{undecided}, where L is the set of object classes. Having undecidable objects means that the predictive models attempt to identify tasks that are undecidable, so that the system does not spend valuable resources on tasks that will not converge to a classification. By way of example, the answer models for predicting the correct answer of a celestial object (galaxy) identification (M_{A}) are responsible for deciding if a celestial object is decidable, as well as identifying the correct object class if the object is decidable, without knowing the consensus rule that is used to assign correct answers to galaxies. Because the number of votes each object has in the dataset varies significantly (e.g., minimum 30, maximum 95, average 44), predicting the correct answer of a galaxy at any step of the process (without knowing how many votes the galaxy has eventually) is a challenging prediction task. For example, two galaxies with the same vote distribution after 30 votes may have different correct answers.

The most commonly used approach in existing crowdsourcing systems for inferring the correct answer of a task is majority voting. This simple approach does not make use of features describing tasks and workers reporting for tasks. The majority voting approach is known to not perform well in predicting the correct answers of certain tasks accurately; in particular, majority voting fails to distinguish decidable tasks from undecidable tasks.

Described herein are supervised learning approaches that can make use of the features of a consensus task. This includes a discriminative learning approach, which can represent the dependency relationships among different features of a task. A discriminative model takes as input f, the complete set of features, and directly predicts the correct answer â conditional on f. It identifies dependency relationships between features in different feature sets and the label to be predicted. Relatively many task features may be selected as informative features for predicting the correct answer when few number of worker reports are available, where as only a few vote features, worker features and vote-worker features may be chosen at this initial stage. As the number of votes collected by the system increases, the task features may be replaced by vote and worker features. When a large number of worker reports are available, fewer task features may be selected for predicting correct answers, since vote, worker and vote-worker features become more informative and they provide major evidence needed to predict correct answers.

The promise of consensus tasks is that the answer that a large percentage of the workers of a crowdsourcing system agree on is actually correct. However, not all tasks reach the desired consensus. Predicting these tasks early allows the system to direct resources to decidable tasks to not to spend valuable resources on tasks that will not reach consensus. By way of example, predicting decidability for galaxy classification tasks is described. Models are built for making the binary prediction of whether a galaxy classification task will reach consensus after all available votes are collected for the task. In addition to the baseline model, which always predicts the most likely label (“undecidable”), models are trained that have access to different subsets of the feature set. Because a task may have any number of votes (e.g., between 30 and 93), many tasks that have agreement after a large number of worker reports collected may turn to be undecidable when all worker reports are collected, and vice versa. Thus, predicting decidability is a challenging prediction task. A number of reports are needed to improve upon the prediction accuracy when no worker reports are available, and the predictions of these models are not perfect even after collecting a very large number of worker reports. Overall for different number of worker reports, task features may help to improve the prediction accuracy to some extent. Task features may help to improve the prediction accuracy from random when few number of worker reports are available. The effect of task features may diminish as more worker reports are collected.

Turning to the problem of predicting the correct answer of a consensus task based on noisy worker reports, the most commonly used approach in crowdsourcing research for predicting the correct answer of a consensus task is majority voting. This approach does not perform well in the galaxy classification domain because it incorrectly classifies many galaxies, particularly the tasks that are undecidable. Two approaches that predict the correct answer using Bayes' rule based on the predictions of the following models: M_{A}( a̅, F(f₀, Ø)), a prior model for the correct answer, and M_{V′}(vᵢ, a̅, f(f₀, hᵢ₋₁)), a vote model that predicts the next vote for a task conditional on the complete feature set and the correct answer of the galaxy. Because vᵢ is the most informative piece of a worker's report and predicting fsᵢ is difficult, only the M_{V′} model may be used to predict a worker's report. The Naive Bayes approach makes the strict independence assumption that worker reports are independent of each other given task features and the correct answer of the task. Formally, Pᵣ( a̅|f), the likelihood of the correct answer being a̅, given feature set f, is computed as below:

$$Pr ( \overline{a} \vert f ) = Pr ( \overline{a} \vert F ( {f}_{0} , {h}_{t} ) ) \approx {M}_{A} ( \overline{a} , F ( {f}_{0} , φ ) ) {\prod }_{i = 1}^{t} {M}_{{V}^{′}} ( {v}_{i} , \overline{a} , F ( {f}_{0} , φ ) ) / {Z}_{n}$$

where Zₙ is a normalization constant. An iterative Bayes update model relaxes the independence assumptions of the Naive Bayes model. The iterative Bayes update model generates a posterior distribution over possible answers at time step t by iteratively applying the vote model on the prior model as given below:

$$Pr ( \overline{a} \vert f ) ∝ Pr ( \overline{a} \vert F ( {f}_{0} , {h}_{t - 1} ) ) Pr ( 〈 {v}_{t} , {f}_{{s}_{t}} 〉 \vert \overline{a} , F ( {f}_{0} , {h}_{t - 1} ) ) / {Z}_{b} \approx {M}_{A} ( \overline{a} , F ( {f}_{0} , φ ) ) {\prod }_{i = 1}^{t} {M}_{{V}^{′}} ( {v}_{i} , \overline{a} , F ( {f}_{0} , {h}_{i - 1} ) ) / {Z}_{b}$$

Another approach is building direct models for predicting the correct answer of a task. A direct model takes as input f, the complete set of features, and predicts a̅.

Another problem is building models for predicting the next vote that a system would receive from a randomly selected worker from the pool of workers based on the reports collected so far for a task and the features of the task. These predictive models may be used by the CrowdSynth framework 102 to predict the way evidences collected for a task may change if more workers are hired for the task. Performing this prediction enables to estimate how the inference of the correct answer of a consensus task may change in the future. This model, symbolized as M_{V}, takes as input the complete feature set f and predicts vᵢ₊₁, the next vote that would be received. It differs from M_{V′} in that the correct answer of a task (a) is not an input to this model. Having access to task features in addition to worker, vote and vote-worker features may produce a significant improvement in predicting the next vote when few number of worker reports are available.

With respect to predicting termination of a task, although the CrowdSynth framework may decide to hire another worker for a task, the execution on a task may stochastically terminate because the system may run out of workers to hire or it may run out of time. Tasks logged in the dataset are associated with different numbers of worker reports. While the planner is making a decision about hiring an additional worker for a task, it does not know whether there is an additional worker report for that task in the dataset. The system has to terminate once all reports for a task are collected.

At any time during the execution, the CrowdSynth framework needs to make a decision about whether to hire an additional worker for each task under consideration. If the framework does not hire another worker for a task, it terminates and delivers the most likely answer that is predicted by the answer model. If the system decides to hire another worker, it collects additional evidence about the correct answer, which may help the system to predict the answer more accurately. But, hiring a worker incurs monetary and time costs. To maximize the utility associated with solving consensus tasks, the framework needs to trade off the long-term expected utility of hiring a worker with the immediate cost. Deliberating about this tradeoff involves the consideration of multiple dimensions of uncertainty. The system is uncertain about the reports it will collect for a given task, and it is not able to observe a̅, the correct answer of a consensus task. This decision-making problem may be modeled as an MDP with partial observability, which uses the answer and next vote models as building blocks. Note that exact solutions of consensus tasks over long horizons is intractable; described herein are approximate algorithms for estimating the expected value of hiring a worker.

Turning to modeling consensus tasks, a consensus task is partially observable because the consensus system cannot observe the correct answer of the task. For simplicity of representation, we model a consensus task as an MDP with uncertain rewards, where the reward of the system at any state depends on its belief about the correct answer. A consensus task may be formalized as a tuple <S, [symbol] ,T,R,l>. sₜεS, a state of a consensus task at time t, is composed of a tuple sₜ=<f₀, hₜ>, where f₀ is the set of task features initially available, and hₜ is the complete history of worker reports received up to time t.

The set of actions [symbol] for a consensus task include H, hire a worker, and [symbol] H, terminate and deliver the most likely answer to the task owner. T(sₜ, α, sₜ₊₁) is the likelihood of transitioning from state sₜ to sₜ₊₁ after taking action α. The transition function represents the system's uncertainty about the world and about worker reports. The system transitions to a terminal state if the selected action is [symbol] H. If the system decides to hire a worker, the transition probability to a next state depends on likelihoods of worker reports and the likelihood of termination. A worker report is a combination of vᵢ, worker's vote, and fₛᵢ, the set of features about the worker. To predict the likelihood of a worker report, the next vote model is used, along with average worker statistics computed from the training data to predict fₛᵢ.

The reward function R(sₜ, α) represents the reward obtained by executing action α in state sₜ. The reward function is determined by the cost of hiring a worker, and the utility function U(â, a̅), which represents the task owner's utility for the system predicting the correct answer as â when it is a̅. For the simple case where there is no chance of termination, R(sₜ,H) is assigned a negative value which represents the cost of hiring a worker. The value of R(sₜ, [symbol] H) depends on whether the answer that would be revealed by the system based on task features and reports collected so far is correct. bₜ is a probability distribution over set A that represents the system's belief about the correct answer of the task, such that for any aεA, bₜ(a)=M_{A}(a, F(f₀, hₜ)). Let â be the most likely answer according to bₜ; the reward function is defined R(sₜ, [symbol] H)=Σₐbₜ( a̅)U(â, a̅). Consensus tasks are modeled as a finite-horizon MDP·l, the horizon of a task, is determined by the ratio of the maximum reward improvement possible (e.g., the difference between the reward for making a correct prediction and the punishment of making an incorrect prediction) and the cost for hiring an additional worker. A policy π specifies the action the system chooses at any state sₜ. An optimal policy π satisfies the following equation for a consensus task of horizon l:

$${V}^{π *} ( {s}_{t} ) = {max}_{α ∈ A} R ( {s}_{t} , α )$$

$${V}^{π *} ( {s}_{t} ) = {max}_{α ∈ A} ( R ( {s}_{t} , α ) + {\sum }_{{s}_{t} + 1} T ( {s}_{t} , α , {s}_{t + 1} ) {V}^{π *} ( {s}_{t + 1} ) )$$

Calculate the value of information (VOI) for any given initial state sᵢ:

$$\begin{matrix}VOI ( {s}_{i} ) ) = {V}^{H} ( {s}_{i} ) - {V}^{H} ( {s}_{i} ) \\ = R ( {s}_{i} , H ) + {\sum }_{{s}_{i + 1}} T ( {s}_{i} , H , {s}_{i + 1} ) {V}^{π *} ( {s}_{i + 1} ) - R ( {s}_{i} , H )\end{matrix}$$

VOI is the expected value of hiring an additional worker in state sᵢ. It is beneficial for the consensus system to hire an additional worker when VOI is computed to be positive.

A state of a consensus task at any time step is defined by the history of observations collected for the task. The state space that needs to be searched for computing an optimal policy for a consensus task grows exponentially in the horizon of the task. For large horizons, computing a policy with an exact solution algorithm is infeasible due to exponential complexity.

Described herein are sampling-based solution algorithms, which can be employed in partially observable real-world systems for solving consensus tasks accurately and efficiently. These algorithms use Monte-Carlo sampling to perform long lookaheads up to the horizon and to approximate the value of information. Instead of searching a tree that may be intractable in size, this approach samples execution paths (i.e., histories) from a given initial state to a terminal state. Co-pending U.S. patent application Ser. No. 13/837,274, entitled “MONTE-CARLO APPROACH TO COMPUTING VALUE OF INFORMATION” describes such techniques, and is hereby incorporated by reference.

For each execution path, it estimates [symbol] the value for terminating at the initial state, and V^{H}, the value for hiring more workers and terminating later. The value of information is estimated as the difference of these values averaged over a large number of execution path samples. Two algorithms are described that use this sampling approach to approximate VOI, but differ in the way they estimate V^{H}. A lower-bound sampling (LBS) algorithm picks a single best termination point in the future across all execution paths, and V^{H} is assigned the expected value of this point. An upper-bound sampling (UBS) algorithm optimizes the best state for termination for each execution path individually. V^{H} is estimated by averaging over the values for following these optimal termination strategies. Both algorithms decide to hire an additional worker if VOI is computed to be positive. After hiring a new worker and updating the current state by incorporating new evidence, the algorithms repeat the calculation of VOI for the new initial state to determine whether to hire another worker.

For any given consensus task modeled as an MDP with partial observability, and any initial state sᵢ, a next state is sampled with respect to the transition function; the likelihood of sampling a state is proportional to the likelihood of transitioning to that state from the initial state. Future states are sampled accordingly until a terminal state is reached. Because sampling of future states is directed by the transition function, the more likely states are likely to be explored. For each state sₜ^{j} on path j, âₜ^{j} is the answer predicted based on the current state. When a terminal state is reached, the correct answer for path j, a̅^{j}, is sampled according to the system's belief about the correct answer at this terminal state, when the system is most confident about the correct answer. An execution path from the initial state sᵢ to a terminal state sₙ^{j} is composed of each state encountered on path j, the corresponding predictions at each state, and the correct answer sampled at the end. It is represented by the tuple: p^{j}=<sⱼ, âᵢ, sᵢ₊₁^{j}, âᵢ₊₁^{j}, . . . , sₙ^{j}, âₙ^{j}, a̅^{j}>.

An execution path represents a single randomly generated execution of a consensus task. For any given execution path, there is no uncertainty about the correct answer or the set of observations that would be collected for the task. Sampling an execution path maps an uncertain task to a deterministic and fully observable execution. To model different ways a consensus task may progress (due to the uncertainty about the correct answer and the worker reports), a library of execution paths (P) is generated by repeating the sampling of execution paths multiple times. This library provides a way to explore long horizons on a search tree that can be intractable to explore exhaustively. If the library includes infinitely many execution paths, it constitutes the complete search tree. Given an execution path pⱼ that terminates after collecting n reports, Vₖ(p^{j}) is the utility for terminating on this path after collecting k-many worker reports. Vₖ(p^{j}) is computed with respect to the answer predicted based on the worker reports collected in the first k steps and the correct answer sampled at the terminal state. Given that c is the cost for hiring a worker, Vₖ(p^{j}) is defined as follows:

$${V}_{k} ( {p}^{j} ) = \{ \begin{matrix}U ( {\hat{a}}_{k}^{j} , {\overline{a}}^{j} ) - kc & if k \leq n & \\ U ( {\hat{a}}_{n}^{j} , {\overline{a}}^{j} ) - nc & if n < k \leq l & \end{matrix}$$

For simplicity of presentation, a constant cost is assumed for hiring workers. The definition of Vₖ(p^{j}) and consequently LBS and UBS algorithms can be generalized to settings in which worker costs depend on the current state.

The terminating value [symbol] is defined with respect to execution path library P as:

$${V}^{H} ( {s}_{i} ) = {\sum }_{{p}^{j} ∈ P} {V}_{i} ( {p}^{j} ) / \vert P \vert$$

The lower-bound sampling (LBS) algorithm approximates V^{H} as given below:

$${V}^{H} ( {s}_{i} ) = {max}_{i < k \leq l} ( {\sum }_{{p}^{j} ∈ P} {V}_{k} ( {p}^{j} ) / \vert P \vert )$$

LBS picks the value of the best termination step in average for all execution paths. This algorithm underestimates V^{H} because it picks a fixed strategy for future, and does not optimize future strategies with respect to different worker reports that could be collected in future states. LBS is a pessimistic algorithm; given that the MDP model provided to the algorithm is correct and the algorithm samples infinitely many execution paths, all hire (H) decisions made by the algorithm are optimal.

The upper-bound sampling (UBS) approximates V^{H} by optimizing the best termination step individually for each execution sequence:

$${V}^{H} ( {s}_{i} ) = {\sum }_{{p}^{j} ∈ P} ( {max}_{i < k \leq l} {V}_{k} ( {p}^{j} ) / \vert P \vert )$$

In distinction to the LBS algorithm, the UBS algorithm overestimates V^{H} by assuming that both the correct state of the world and future state transitions are fully observable, and thus by optimizing a different termination strategy for each execution sequence. The UBS algorithm is an optimistic algorithm; given that the MDP model provided to the algorithm is correct and the algorithm samples infinitely many execution paths, all not hire ( [symbol] H) decisions made by the algorithm are optimal.

Instead of approximations, MC-VOI simulations can be used to determine execution paths, with the states through the execution paths tracked and analyzed to determine an estimated number of workers. This may be for static data, or adaptive, as described below.

FIG. 2 summarizes some of the example steps that may be taken to handle a task, beginning at step 202 where the task is received, e.g., on demand or input from a queue or the like. Step 204 represents extracting the task data, e.g., preferences and other properties associated with the task, such as answer quality (e.g., a value such as a percentage as to when a consensus vote percentage is sufficient), value of answers of different qualities, deadlines, and cost, e.g., per person and/or a total budget. Not all of these data need be present, and additional data may be provided.

Step 206 represents determining zero or more workers to hire based upon a prediction and task data. Note that there are different ways to estimate whether additional worker contributions will add value to a current answer. One way is to estimate the number of workers in advance, e.g., by running simulations. Another way is to hire additional workers as needed; for example, each time an answer is received, that answer may be used to update the state of the prediction models, which then may be used to determine whether hiring another worker or terminating with the result as current answer is the better option. Step 214 represents this via different branches until done.

Step 206 represents determining the workers to hire. This may be based upon the task data, e.g., skill level, deadline (versus availability), budget and so forth may be factored into selection of the desired set of workers. In a dynamic scenario in which workers are hired on demand until the task is complete, a time will be reached when no more workers are needed, either because the task is sufficiently complete or the budget limit is reached. This is indicated by the dashed arrow from step 206 to step 214. It is also possible that no workers are ever needed, e.g., the starting data (such as obtained from computer processing of a task) indicates that the task was performed sufficiently (e.g., confidence criteria was reached) without needing additional work.

Step 208 represents accessing the worker pool to get one or more workers. Step 210 sends the worker or workers the task.

Step 212 represents collecting a report from each worker. If the number of predicted workers is fixed in advance, step 214 waits until the reports are in, or at least a sufficient number of them (so that a worker cannot hold up task completion). If the number of predicted workers is dynamic, e.g., whether more work is needed or whether the task is complete, step 214 returns to step 206 to make this decision based upon prediction, as described herein.

When the task is complete, step 216 represents processing the reports into payments, and making the payments. Note that payment may be contingent on the workers contribution (e.g., towards the consensus or correct answer), skill level, and/or other factors such as time of day). Payment is described below, including fair payment schemes.

Step 218 represents processing the reports into an answer, and returning that answer to the task owner.

### Cold Start

Turning to another aspect, in one implementation, in predicting answers, there are basically two versions of Monte-Carlo sampling, namely one when there is start data (as described above) and one when there is no start data (referred to as cold start). In both versions, predictive modeling is used to build models of domain dynamics and the system samples from these predictive models to generate paths. The start data version uses existing data to learn the models and uses these fixed models thereafter. The cold start version adaptively learns these models and keeps a distribution over possible models; the cold start version uses sampling to both sample predictive models and future transitions from the sampled predictive models.

With respect to cold start, namely the application of Monte-Carlo approaches for estimating VOI in settings where accurate models of the world do not exist, (e.g., using the cold start mechanism 108 of FIG. 1), adaptive control of consensus tasks are used as the illustrative example. Adaptive control of consensus tasks has a number of characteristics that distinguish it from other problems with inherent exploration-exploration tradeoffs. In solving consensus tasks, a system needs to make decisions without receiving continuous reinforcement about its performance. In contrast to the traditional problems in which any action help to explore the world, the exploration of a consensus task permanently terminates once [symbol] H action is taken. As set forth above, in consensus tasks, the domains of answers and worker predictions are finite and known. The values for the horizon, utilities for correct identification of answers and for worker costs are quantified by task owners. However, both the priors on the correct answers of consensus tasks and the transition models are unknown, and need to be learned in time. Therefore, a successful adaptive control system needs to reason about its uncertainty about the specific model of the world as well as its uncertainty over the way a task may progress to make hiring decisions appropriately.

One adaptive control methodology is referred to as CrowdExplorer. CrowdExplorer is based on an online learning module for learning a set of probabilistic models representing the dynamics of the world (i.e. state transitions), and a decision-making module that optimizes hiring decisions by simultaneously reasoning about its uncertainty about its models and the way a task may stochastically progress in the world. One of the challenges is that the number of state transitions that define the dynamics of consensus tasks grows exponentially in the horizon. However, the next state of the system is completely determined by the vote of a next worker. Thus, the transition probabilities may be captured with a set of models that predict the vote of a next worker based on the current state of the task. This implicit representation of the world dynamics significantly reduces the number of variables to represent consensus tasks. Formally, state transitions may be modeled with a set of linear models M={M₁, . . . , M_{|L|}}, where Mᵢ predicts the likelihood of a next worker predicting the answer as aᵢεL. Each model takes as input a set of features describing the current state, including the ratio of number of collected votes to the horizon, and for each vote class, the ratio of number of votes collected for that class to the total number of votes collected. Let xₜ denote k dimensional feature representation of state sₜ and each model Mᵢ is defined by k-dimensional vector of weights wᵢ, then transition probabilities may be estimated as below, where sₜ₊₁=sₜ∪{oₜ₊₁=aᵢ}.

$$T ( {s}_{t} , H , {s}_{t + 1} ) = \frac{{e}^{{w}_{i}^{T} {x}_{t}}}{{Σ}_{i} {e}^{{w}_{j}^{T} {x}_{t}}}$$

The linear models are constantly updated using an online learning algorithm. Initially, the models are uninformative as they lack training instances. As workers provide votes, the system observes more data and consequently the models starts to provide useful transition probabilities. Because these models are latent, the parameters wᵢ are represented as random variables. The online learning consequently is implemented as a Bayesian inference procedure using Expectation Propagation. More specifically, the inference procedure provides a Gaussian posterior distribution over the model parameters wᵢ. One of the benefits of the Bayesian treatment is that the variance of this posterior distribution captures the notion of uncertainty/confidence in determining the model. Intuitively, when there is no or very little data observed, the inference procedure usually returns a covariance matrix with large diagonal entries and corresponds to the high degree of difficulty in determining the model from a small amount of data. This uncertainty quickly diminishes as the system sees more training instances. Reasoning about such uncertainties enables the method to manage the tradeoff between exploration, learning better models by hiring more workers, and exploitation, selecting the best action based on its models of the world.

The backbone of the CrowdExplorer is the decision-making module. This module uses Monte-Carlo sampling of its distribution of predictive models to reason about its uncertainty about the domain dynamics, and uses the MC-VOI algorithm to calculate VOI based on its uncertainty about the domain dynamics and future states. Given the exponential search space of consensus tasks, Monte-Carlo planning as described herein is able to make decisions efficiently and accurately under these two distinct sources of uncertainty. The decision-making model is thus based on the above-described MC-VOI algorithm, which includes solving consensus tasks when perfect models of the world are known. MC-VOI samples future state, action transitions to explore the world dynamics.

Described herein is expanding the MC-VOI algorithm to reason about the model uncertainty that is inherent to adaptive control. Each call to the SampleExecutionPath function represents a single iteration (sampling) of the MC-VOI algorithm. Example details of the CrowdExplorer methodology is given in the following example algorithm:

```
begin
  initialize Pr_{M} = {Pr_{M}_{₁}, ..., Pr_{M}_{_{|L|}}}
  foreach task i do
    sⁱₜ ← { }
    repeat
      VOI ← CalculateVOI (sⁱₜ, Pr_{M})
      if VOI > 0 then
        oₜ₊₁ ← GetNextWorkerVote
        AddLabel (Pr_{M}, oₜ₊₁)
        sⁱₜ ← sⁱₜ ∪ {oₜ₊₁}
        sⁱₜ ← sⁱₜ₊₁
      end
    until VOI ≦ 0 or t = h
    output sⁱₜ.â
  end
end
CalculateVOI(sₜ:state, Pr_{M}:model distribution)
begin
  repeat
    { [symbol] , ..., [symbol] } ← SampleModels(Pr_{M})
    SampleExecutionPath(sₜ, { [symbol] , ..., [symbol] }, h)
  until Timeout
  return VOI ← sₜ.V^{H} - sₜ, [symbol]
end
```

For any state sₜⁱ of a consensus task i, the methodology uses sampling to estimate values of states for taking different actions as an expectation over possible models and stochastic transitions. At each iteration, the methodology first samples a set of models ( [symbol] , . . . , [symbol] ) from the model distribution Pr_{M}. These sampled models are provided to MC-VOI to sample future state transitions from sₜⁱ by continuously taking action H until reaching the horizon. The resulting state transitions form an execution path. Each execution path represents one particular way a consensus task may progress if the system hires workers until reaching the horizon. The aggregation of execution paths forms a partial search tree over possible states. The tree represents both the uncertainty over the models and over future transitions.

FIGS. 3A and 3B show search trees generated by CrowdExplorer when there is high uncertainty (FIG. 3A) and low uncertainty over models (FIG. 3B).

For each state sₜ on the partial search tree, the methodology uses recursive search on the tree to estimate values for hiring a worker (sₜ·V^{H}) and for terminating (sₜ· [symbol] ), and to predict the most likely answer for that state (sₜ·â) (as shown in the next algorithm). It decides to hire a worker if VOI for the initial state is estimated to be positive. Once the vote of the next worker arrives, the vote is used to update the predictive models and update the state of the task. This computation is repeated for future states until the budget is consumed or VOI is estimated to be non-positive. The methodology terminates the task by delivering the predicted answer (â) and moves on to the next task.

The variance of the predictive models estimated dynamically by the online learning algorithm guides the decision making algorithm in controlling the exploitation-exploration tradeoff. When the variance is high, each sampled model provides a different belief about the way future workers will vote. Execution paths reflecting these diverse beliefs lead to high uncertainty about the consensus answer that will be received at the horizon. Consequently, this leads to more exploration by hiring workers. When the variance is low, sampled models converge to a single model. In this case, the hiring decisions are guided by exploiting the model and selecting the action with the highest expected utility. This behavior is illustrated in FIGS. 3A and 3B for a simplified example, in which oᵢε{0, 1}, h=3 and majority rule is the consensus rule. FIGS. 3A and 3B display the partial search trees generated for initial state s₁={o₁=1} when there is high uncertainty and low uncertainty over the models, respectively. In FIG. 3A, high uncertainty over the models leads to high uncertainty over the correct answer and VOI is estimated to be high. In FIG. 3B, sampled models agree that future workers are likely to vote 1. As a result, execution paths where workers vote 1 are sampled more frequently. The correct answer is predicted to be 1 and VOI is estimated to be not positive.

The approach uses the sampling methodology of the MC-VOI algorithm for sampling an execution path (p) for a given sampled model (\tilde{M}). Example code for sampling an execution path is given below:

| SampleExecutionPath(sₜ:state, \tilde{M}:set of models, h:horizon) | | |
|---|---|---|
| begin | | |
| \| | if t = h then | |
| \| | \| | aₚ* ← ConsensusRule(sₜ) |
| \| | else | |
| \| | \| | oₜ₊₁ ← SampleNextVote(sₜ, \tilde{M}) |
| \| | \| | sₜ₊₁ ← sₜ ∪ {oₜ₊₁} |
| \| | \| | aₚ* ← SampleExecutionPath(sₜ₊₁, \tilde{M}, h) |
| \| | end | |
| \| | sₜ·N[aₚ*] ← sₜ·N[aₚ*] + 1 | |
| \| | sₜ·N ← sₜ·N + 1 | |
| \| \| | ${s}_{t} \cdot {V}^{H} ← ( \frac{{max}_{a ∈ A} {s}_{t} \cdot N [ a ]}{{s}_{t} \cdot N} \times u ) - ( t \times c )$ | |
| \| | if t < h then | |
| \| \| \| \| | \| \| \| \| | ${s}_{t} \cdot {V}^{H} ← \frac{{\sum }_{{s}_{t + 1}^{′} ∈ Φ ( {s}_{t} )} ( {s}_{t + 1}^{′} \cdot V \times {s}_{t + 1}^{′} \cdot N )}{{s}_{t} \cdot N}$ |

| | |
|---|---|
| \| | end |
| \| | sₜ·V ← max(sₜ· [symbol] , sₜ·V^{H}) |
| \| | sₜ·â ← argmax_{a∈A}sₜ·N[a] |
| \| | return aₚ* |

end

The algorithm generates execution paths by recursively sampling future votes from the predictive models until reaching the horizon as described above. At the horizon, it uses the consensus rule to determine the correct answer corresponding to the path (aₚ*). For each path, the algorithm uses aₚ* to evaluate the utilities of each state on the path for taking actions H and [symbol] H by taking into account c, the cost of worker.

For each state sₜ visited on a path, the algorithm keeps the following values: sₜ·N as the number of times sₜ is sampled, sₜ·N[a] as the number of times a path visited sₜ reached answer a, sₜ·N[a]/sₜ·N as the likelihood at sₜ for the correct answer being a, sₜ·̂a as the predicted answer at sₜ. sₜ· [symbol] , the value for terminating, is estimated based on the likelihood of predicting the answer correctly at that state. Φ(sₜ) is the set of states reachable from sₜ after taking action H. sₜ·V^{H}, the value for hiring more workers, is calculated as the weighted average of the values of future states accessible from sₜ.

### Payment

Turning to another aspect, payment, represented by the payment component 120 in FIG. 1, described herein is a payment rule, referred to as a consensus prediction rule, which uses the consensus of other workers to evaluate the report of a worker. The consensus prediction rule has better fairness properties than other rules.

Designing a crowdsourcing application involves the specification of incentives for services and the checking of the quality of contributions. Methodologies for checking quality include providing a payment if the work is approved by the task owner and also hiring additional workers to evaluate contributors' work. These approaches place a burden on people and organizations commissioning tasks, and there are multiple sources of inefficiency. For example, there can be strategic manipulation of work by participants that reduces their contribution but increases payments. Task owners may prefer to reject contributions simply to reduce the payments they owe to the system. Moreover neither a task owner nor the task market may know the task well enough to be able to evaluate worker reports.

Described herein are incentive mechanisms that promote truthful reporting among workers of a crowdsourcing system and prevent task owner manipulations. Again, while consensus tasks are used as examples, the ideas presented here can be generalized to many settings in which multiple reports collected from people are used to make decisions. As set forth above, consensus tasks are aimed at determining a single correct answer or a set of correct answers to a question or challenge, such as identifying labels for items, quantities, or events in the world, based on multiple noisy reports collected from human workers. Consensus tasks can also be subtasks of a larger complementary computing task, where a computer system is recruiting human workers to solve pieces of a larger problem that it cannot solve. For example, a computer system for providing real-time traffic directions may recruit drivers from a certain area to report about traffic conditions, so that the system is able to provide up-to-date directions more confidently. Different payment rules for incentivizing workers in crowdsourcing systems and the properties of these rules may be used; existing payment rules used in consensus tasks are vulnerable to worker manipulations.

In general, the consensus prediction rule couples payment computations with planning, to generate a robust signal for evaluating worker reports. This rule rewards a worker based on how well her report can predict the consensus of other workers. It incentivizes truthful reporting, while providing better fairness than known rules such as peer prediction rules.

Peer prediction and consensus prediction rules make strong common knowledge assumptions to promote truthful reporting. For the domain of consensus tasks, these assumptions mean that every worker shares the same prior about the likelihoods of answers and the likelihoods of worker reports, and the system knows this prior. This assumption is one of the biggest obstacles in applying peer and consensus prediction rules in a real-world system, in which these likelihoods can only be predicted based on noisy predictive models. In settings where common knowledge assumptions do not hold, workers can be incentivized to communicate and collaborate with the system to correctly estimate the true prior, and the true likelihoods of worker reports.

The term “worker's inference” refers to the worker's true belief about the correct answer of a task. A worker's report to the system may differ from the inference, for example if the worker strategizes about what to report. A general goal of the system is to deduce an accurate prediction of the correct answer of a task by making use of multiple worker reports.

Let I denote the set of workers in worker population, A={a₁, . . . , aₙ} denote the set of possible answers for task tεT. f is the set of features describing the task and workers. Task t is a consensus task if there exists a mapping t→a*εA, where a* is the correct answer of task t.

Let A* be a random variable for the correct answer of a given task, and Cₚ be another random variable for the answer inferred by a random worker in the population. A* is stochastically relevant for Cₚ conditional on f. That is, for any distinct realization of A*, ã and ā, there exists a realization of Cₚ, cₚ, such that Pr(Cₚ=cₚ|A*=ã, f)≠Pr(Cₚ=cₚ|A*=ā, f).

Let Cᵢ be a random variable denoting the answer inferred by worker i, and Cⱼ be another variable denoting the answer inferred by a random worker from the remaining population I₋ᵢ=I\{i}. For any worker i in the worker population, Cᵢ is stochastically relevant for Cⱼ conditional on f.

For simplicity, Definition 1 assumes consensus tasks to have a single correct answer; however, the results presented in this work generalize to cases in which a set of answers may serve as correct answers. The second condition of Definition 1 ensures that the worker population is informative for a given task. The third condition is the foundation of the truth promoting payment rules that are described below. This condition is realistic for many domains in which worker inferences about a task depends on the correct answer of the task or the hidden properties of the task, thus a worker's inference helps to predict other workers' inferences. For example, a worker classifying a galaxy as a spiral galaxy increases the probability that another worker will provide the same classification.

A successful crowdsourcing system needs to satisfy both task owners and workers. Thus, the system designers need to generate a policy for solving a given task, and provide compelling and fair incentives to workers. To address these challenges, a system for solving consensus tasks needs to generate models that predict the correct answer of a task at any point during execution as well as the worker reports that will be obtained by the system. In addition, based on these models, the system needs a policy for deciding whether to hire a new worker or to terminate and deliver the most likely answer to the task owner, and provide payments to workers in return for their effort.

The models for predicting the correct answer and for predicting worker reports makes inferences based on a set of features that represent the characteristics of tasks and workers. To build these models, the system collects data about the system, workers, and tasks being executed. For a given task, feature set Fₜ include features that are initially available in the system. Fₜ may contain features of the task (e.g., task difficulty, task type and topic), features of the general worker population (e.g., population competency), and features about the components of the system (e.g., minimum and maximum incentives offered). Feature set F_{wi} includes features of a particular worker i, which may include the personal competency of the worker, her availability and her abilities. Feature set Fᵢ=F_{wi}∪Fₜ represents the complete set of evidential observations or features relevant for making predictions about worker i's report. After collecting m worker reports, F=Fₜ∪F_{w1}∪ . . . ∪F_{wm} represents a complete set of evidential observations or features relevant for predicting the correct answer of a task. F may contain hidden features (e.g., the difficulty of a task), which may need to be predicted to make accurate inferences about the correct answer and about the worker reports. Fᵢ is provided as input to the model that predicts the report of worker i. The full feature set F is provided as input to the model that predicts the correct answer of a task. For simplicity of notation, Pr(X|F=f) is denoted as Pr_{f} (X).

The system uses two predictive models for making hiring decisions and for calculating payments: The answer model (M_{A}) and the report model (M_{R}). M_{A}(a, fₜ) is the prior probability of the correct answer being a given the initial feature set of the task. For example, if a galaxy has features that resemble a spiral, the prior probability of this galaxy being a spiral galaxy is higher. M_{R}(rᵢ,a*,fᵢ) is the probability of worker i reporting rᵢ given that the correct answer of the task is a* and the set of features relevant to the worker report is fᵢ. The likelihood of a worker identifying a galaxy correctly may depend on the features of the task and of the worker. This likelihood tends to be relatively higher if the galaxy is easy to classify, or the worker is competent. Because Fₖ includes the relevant features to predict any kth worker's report, for all worker couples i and j, Rᵢ and Rⱼ are independent given Fᵢ, Fⱼ and A*. At each point during execution, the system makes a decision about whether to hire a new worker or terminate the task. When it decides not to hire additional workers, it deducts a consensus answer â based on aggregated worker reports and delivers this answer to the owner of the task. Given a sequence of reports collected from workers, r={r₁, . . . , rₘ}, it chooses â as:

$$\hat{a} = {argmax}_{a ∈ A} {Pr}_{f} ( {A}^{*} = a \vert {R}_{1} = {r}_{1} , … , {R}_{m} = {r}_{m} )$$

The system implements a policy for deciding when to stop hiring workers and deliver the consensus answer to the task owner. For simplicity of analysis, we limit policies to make decisions about how many workers to hire and not to make decisions about who to hire and how much to pay. A sample policy that we will be using through the presentation continuously checks whether the system's confidence about the correct answer has reached a threshold value T. The policy hires a new worker if target confidence T has not been reached after receiving a sequence of reports r:

$$( {max}_{a ∈ A} Pr ( {A}^{*} = a \vert R = r , ℱ = f ) ) < T$$

Let π be the policy implemented by the system and define a function M_{π} such that for a given sequence of worker reports r and feature set f, M_{π} (r, f) is Ø if π does not terminate after receiving r, and is â, the consensus answer, otherwise.

Among various factors that motivate workers, including enjoyment, altruism and social reward, monetary payments are the most generalizable and straightforward to replicate, and they can be used to shape the behavior of the worker population to improve the performance of a system. For example, a system for acquiring real-time traffic information may increase payment amounts if requested information is urgently needed. Described in general are quantifiable payments as incentives in crowdsourcing tasks, which can be monetary payments or reputation points. An intuitive approach to rewarding workers in consensus tasks is rewarding agreements with the correct answer. However, the correct answer may take too long to be revealed or may never be revealed. Moreover, the signal about the correct answer may be unreliable; if the correct answer is revealed by the task owner, the owner may have an incentive to lie to decrease payments.

Described are payment rules that reward workers without knowing the correct answer. These rules use peer workers' reports to evaluate a worker, and does not require input from task owners, thus preventing task owner manipulations. An automated system for solving consensus tasks needs to calculate payments without knowing about the correct answer.

In consensus tasks, workers report on a task once and maximize their individual utilities for the current task. The common knowledge assumptions translate to the domain of consensus tasks as follows: The probability assessments performed by models MA and M_{R} are accurate and common knowledge. These assumptions can be realized by a crowdsourcing system by collecting evidence about previous tasks and workers, and by building accurate predictive models. For cases in which predictions of the system are accurate but individual workers' predictions are not, the assessments of the system can be made common knowledge with public revelation.

A consensus task may be modeled as a game of incomplete information in which players' strategies comprise their potential reports. Bayesian-Nash equilibrium analysis may be used to study the properties of payment rules. A worker's report is evaluated based on a peer worker's report for the same task or a subset of such reports. τᵢ(rᵢ,r₋ᵢ)→ [symbol] denotes the system's payment to worker i, based on rᵢ, worker i's report, and r₋ᵢ, a sequence of reports collected for the same task excluding rᵢ. C₋ᵢ is a random variable for the sequence of inferences by all workers except worker i. Ω_{R} is the domain of worker inferences and reports.

Let sᵢ^{t} be a reporting strategy of worker i such that for all possible inferences cᵢ the worker can make for task t, sᵢ^{t}(cᵢεΩ_{R})→rᵢεΩ_{R}. s^{t} is a vector of reporting strategies for workers reporting to the system, sᵢ₋₁^{t} is defined as s^{t}\{sᵢ^{t}}. s^{t} is a strict Bayesian-Nash equilibrium of the consensus task t if, for each worker i and inference cᵢ,

$${\sum }_{{c}_{- i}} {τ}_{i} ( {S}_{i}^{t} ( {c}_{i} ) , {s}_{- i}^{t} ( {c}_{- i} ) ) {Pr}_{f} ( {C}_{- i} = {c}_{- i} \vert {C}_{i} = {c}_{i} ) > {\sum }_{{c}_{- i}} {τ}_{i} ( {\hat{r}}_{i} , {s}_{- i}^{t} ( {c}_{- i} ) ) {Pr}_{f} ( {C}_{- i} = {c}_{- i} \vert {C}_{i} = {c}_{i} )$$

$$for all {\hat{r}}_{i} ∈ {Ω}_{R} \backslash \{ {s}_{i}^{t} ( {c}_{i} ) \} .$$

A strategy sᵢ^{t} is truth-revealing if for all cᵢεΩ_{R}, sᵢ^{r}(cᵢ)=cᵢ. M=(t, π, τ), a mechanism for task t with policy π and payment rule τ, is strict Bayesian-Nash incentive compatible if truth-revelation is a strict Bayesian-Nash equilibrium of the task setting induced by the mechanism. Proper scoring rules may be used as the main building blocks for designing payment rules that promote truthfulness in consensus systems. Proper scoring rules are defined for the forecast of a categorical random variable. The set of possible outcomes for the variable is Ω={ω₁, . . . , ωₙ}. A forecaster reports a forecast p, where p is a probability vector (p₁, . . . , pₙ), and Pₖ is the probability forecast for outcome ωₖ. A proper scoring rule S takes as input the probability vector p and the realized outcome of the variable ωᵢ, and outputs a reward for the forecast.

Let the probability vector q be the forecaster's true forecast for the random variable, a function S is a strictly proper scoring rule if the expected reward is maximized when p=q. Function S measures the performance of a forecast in predicting the outcome of a random variable. Three well-known strictly proper scoring rules are:

1. Logarithmic scoring rule:

S(p,ωᵢ)=ln(pᵢ)

2. Quadratic scoring rule:

$$S ( p , {ω}_{i} ) = 2 {p}_{i} - {\sum }_{{ω}_{k}} {p}_{k}$$

3. Spherical scoring rule:

$$S ( p , {ω}_{i} ) = \frac{{p}_{i}}{{{Σ}_{{ω}_{k}} ( {p}_{k}^{2} )}^{1 / 2}}$$

Turning to using proper scoring for calculation of truth-promoting payments in consensus tasks, a public signal is picked for which a worker's report is stochastically relevant. The worker's report gives a clue about what the value of the signal will be. The worker's report may be used to generate a forecast about the signal and reward the worker based on how well the forecast predicts the realized value of the signal. From the definition of proper scoring rules, the reward of the worker is maximized when rᵢ=cᵢ. Described herein are signals that can be used to evaluate worker reports and provide methods for calculating the payment of a worker reporting to a real-world consensus system.

With respect to applying existing payment rules to consensus tasks, basic payment rules are ones where worker payments depend on agreements among the reports of workers, independent of the likelihood of agreement. Basic payment rules are not guaranteed to promote truthful reporting for consensus tasks.

Described herein is a rule referred to as the consensus prediction rule, which rewards a worker according to how well her report can predict the outcome of the system (i.e., the consensus answer that will be decided by the system), if she was not participating in it. Calculation of this payment for the worker is a multi-step (e.g., two-step) process. In a first step, the worker's report is used as a new feature to update the system's predictions about the likelihood of answers and worker reports. Based on these updated predictions, the process simulates the system to generate a forecast about the likelihoods of possible consensus answers. In a second step, reports from all other workers are used to predict the most likely consensus answer as if the worker in question never existed. The worker is rewarded based on how well the forecast generated based on only her report can predict the realized consensus answer by her peers. This payment rule forms a direct link between a worker's payment and the outcome of this system. Because the outcome of a successful system is more robust to erroneous reports than the signal used in peer prediction rules, this payment rule has better fairness properties.

By way of example, consider a galaxy classification task example. In this example, the system follows the policy that terminates after collecting reports from four workers; assume report sequence {e, s, e, e} is collected (where e means elliptical and s means spiral). To calculate the payment for the first worker, this worker's reporting e increases the likelihood of the correct answer being e and other workers reporting e. To generate the forecast about the consensus answer, as there are not any real worker reports, all possible report sequences from four hypothetical workers are simulated. Next, the likelihood of each simulated sequence is calculated, along with the consensus answer for that sequence, based on updated answer priors and report likelihoods. The cumulative likelihoods of consensus answers over all possible report sequences form the forecast. The forecast computed for this example for the set of possible values (e,s) is (0.85, 0.15), for example. The most likely consensus answer is then predicted based on second, third and fourth workers' reports. In this example, the most likely answer is e, since the other workers reported the sequence {s, e, e}. The first worker is rewarded ln(0.85) based on the likelihood of answer e in the forecast when the logarithmic rule is used to calculate payments.

This example demonstrates the fairness properties of consensus prediction payments. When normalized payments are computed with this rule, the payment vector is (1, 0, 1, 1). As shown by this example, the reward of workers are not affected by the erroneous reports as long as the system can predict the correct answer accurately based on other workers' reports.

Turning to a formal definition of the consensus prediction rule, let t be a consensus task, r be the sequence of worker reports collected for the task, and r₋ᵢ, be the sequence excluding worker i's report. Â₋ᵢ is a random variable for the consensus answer decided by the system if the system runs without access to worker i. In defining consensus prediction payments, assume that a worker's inference is stochastically relevant for Â₋ᵢ given feature set f. This is a realistic assumption because an inference of a worker provides evidence about the task, its correct answer, and other workers' inferences, which are used to predict a value for Â₋ᵢ.

For a given consensus task t and policy π, let Â₋ᵢ be the consensus answer predicted based on r₋ᵢ. M=(t, π, τ^{c}) is strict Bayesian-Nash incentive compatible for any worker i, where

τᵢ^{c}(rᵢ,r₋ᵢ)=S(p^{c},â₋ᵢ),

where
for all aₖεA, pₖ^{c}=Pr_{f}(Â₋ᵢ=aₖ|Cᵢ=rᵢ)

Proof. The expected payment of worker i is:

$${V}_{i} = {\sum }_{a ∈ A} Pr ( {\hat{A}}_{- i} = a \vert {C}_{i} = {c}_{i} ) Γ ( {\hat{A}}_{- i} = a \vert {R}_{i} = {r}_{i} )$$

Given that Cᵢ is stochastically relevant for Â₋ᵢ and S is a proper scoring rule, Vᵢ is uniquely maximized if for all cᵢεA, sᵢ(cᵢ)=cᵢ.

Payments can be calculated with the consensus prediction rule for consensus tasks in the equilibrium when all workers report their true inferences. The calculation of τᵢ^{c} payments is a two step process; generating a forecast about Â₋ᵢ based on worker i's report, and calculating a value for â₋ᵢ based on r₋ᵢ.

To generate a forecast for Â₋ᵢ, the process simulates the consensus system for all possible sequences of worker reports that reach a consensus about the correct answer. L_{Ø} is defined as the set of all such sequences. For any sequence r′ in L_{Ø}, Mπ(r′,t) is the consensus answer decided based on reports in r. For each r′, Pr_{f} (r′|rᵢ) is calculated, as the likelihood of report sequence r′ conditional on the fact that worker i already provided report rᵢ for the same task. Pr_{f}(Â₋ᵢ, =a|Cᵢ=rᵢ) is computed as the cumulative probabilities of all r′εL_{Ø} that converge to answer a. For any value of aεA and riεΩR, Pr_{f}(Â₋ᵢ, =a|Cᵢ=rᵢ) is computed as given below:

$${Pr}_{f} ( {\hat{A}}_{- i} = a \vert {C}_{i} = {r}_{i} ) = {\sum }_{{r}^{′} ∈ {L}_{φ}} {Pr}_{f} ( {r}^{′} \vert {r}_{i} ) {1}_{\{ a \}} ( {M}_{π} ( {r}^{′} , f ) )$$

The report of worker i is used as a feature to predict the likelihood of a report sequence r′εL_{Ø}. Using the Bayes rule, Pr_{f}(r′|rᵢ) is calculated as:

$${Pr}_{f} ( {r}^{′} \vert {r}_{i} ) ∝ {\sum }_{{a}^{*} ∈ A} {M}_{A} ( {a}^{*} , {f}_{t} ) {M}_{R} ( {r}_{i} , {a}^{*} , {f}_{i} ) {\prod }_{l = 1}^{\vert {r}^{′} \vert} {M}_{R} ( {r}_{l} , {a}^{*} , {f}_{l} )$$

The second step of τᵢ^{c} calculation is predicting the realized value for Â₋ᵢ, based on r₋ᵢ, the actual set of reports collected from workers excluding worker i. â₋ᵢ, the most likely value for Â₋ᵢ, based on r₋ᵢ, is calculated as follows: If there exists a substring of r₋ᵢ that starts with the first element of r₋ᵢ and converges on an answer, â₋ᵢ is assigned the value of this answer. Otherwise, calculating â₋ᵢ requires simulating all report sequences that start with r₋ᵢ and reach a consensus on the correct answer. Lᵣ_{_{−i}} is the set of such sequences. â₋ᵢ is the answer that is most likely to be reached by the report sequences in Lᵣ_{_{−i}}.

$${\hat{a}}_{- i} = {argmax}_{a ∈ A} {\sum }_{{r}^{′} ∈ {L}_{{r}_{- i}}} {Pr}_{f} ( {r}^{′} \vert {r}_{- i} ) {1}_{\{ a \}} ( {M}_{π} ( {r}^{′} , f ) )$$

Calculating payments with the consensus prediction rule is computationally more expensive than computing other payment rules, as an iteration over an exponential number of report sequences is used. The bottleneck of this computation is the calculation Pr_{f}(Â₋ᵢ, =a|Cᵢ=rᵢ). However, this value may be approximated by using importance sampling. Let X be a random variable for the value of Pr_{f}(Â₋ᵢ, =a|Cᵢ=rᵢ). Sampling a report sequence r′εL_{Ø}, such that the likelihood of the sample is proportional to h(r′)=Pr_{f}(r′|rᵢ), takes linear time in the length of r′. After sampling n report sequences r′₁, . . . , r′ₙ, the expected value of X is computed as μ=Σₜ₌₁ⁿg(r′ₜ), where g(r′ₜ)=1_{{a}}(M_{π}(r′ₜ,f)), and the variance is computed as σ²=Varₕ(g(r′))/n. Let εₛ be a constant and define λₛ as the likelihood that the error in calculating Pr_{f}(Â₋ᵢ, =a|Cᵢ=rᵢ) exceeding constant εₛ. Using Chebyshev's inequality, n, the number of samples needed to bound λₛ, may be calculated as n≦σ²/λₛ.

The consensus prediction payment rule incentivizes workers to report truthfully under two conditions, namely that worker and answer models are common knowledge among the system and the workers, a worker's inference (Cᵢ) is stochastically relevant to Â₋ᵢ, the consensus answer that would be decided by the system without this worker's inference. Returning to the galaxy classification example, assume all workers are equally competent in predicting the correct answer of a task. A worker inferring the correct answer of a galaxy as s increases the likelihood of the correct answer being s and also the likelihood of other workers inferring s. Consequently the worker's inference changes the likelihood of the value of Â₋ᵢ, which satisfies the stochastic relevance requirement. Given the common knowledge assumptions, the system can best predict Â₋ᵢ if the worker reports truthfully. Thus, a worker maximizes her payment by reporting truthfully, even when she infers the unlikely answer, when other workers are reporting truthfully. The same reasoning can be used for worker populations including workers of varying competencies. For example, a system may have access to a low ratio of expert workers that can predict the correct answer with high accuracy and a larger ratio of workers that can barely do better than random. When the common knowledge assumption is satisfied, the system is able to distinguish competent workers from incompetent workers and calculate payments accordingly. For example, the influence of an expert's inference on predicting the system's likelihood of the correct answer and on predicting other workers' inferences would be different than the influence of a non-expert's inference. In such a domain, as long as the common knowledge assumptions are satisfied and the system can distinguish expert and non-expert workers, all workers are incentivized to report truthfully regardless of their relative ratios.

A consensus system may implement different policies from simple to complicated to decide on a consensus answer. The policy implemented in the system is used in the calculation of consensus prediction payments. This may raise a question about whether the implemented policy may effect the behavior of workers. The policy is used to calculate the signal for evaluating worker i's report (i.e., the realized value of Â₋ᵢ, the answer that would be decided by the system without worker i's report). We will show that a worker cannot affect the evaluation signal Â₋ᵢ with its report to the system, regardless of the policy implemented. Given that worker and answer models are common knowledge, a worker may affect Â₋ᵢ only by influencing r₋ᵢ, the sequence of worker reports obtained from workers other than i. We will consider the approaches a worker may take to influence r₋ᵢ; (1) by influencing the workers that are hired by the system, and (2) by influencing the number of workers hired by the system. Given the definition of the policy, the system does not control who is hired next, so a worker cannot influence the workers that are hired. Moreover, the prediction of Â₋ᵢ is independent of the number of workers hired by the system, as this calculation considers report sequences of any lengths that converge on an answer. Thus, a worker cannot influence the evaluation signal, regardless of the policy implemented. Due to the proper scoring rules used in payment calculations, a worker's expected payment depends on how well the realized value of Â₋ᵢ can be predicted based on the worker's report. Under the assumption that worker and answer models are common knowledge and other workers are reporting truthfully, the worker maximizes her expected payment always by reporting truthfully, regardless the policy implemented. The same reasoning can be used to conclude that the implemented policy does not affect the behavior of workers when peer prediction rules are used to incentivize workers.

The consensus prediction payment rule may have practical advantages over other rules such as the peer prediction rule due to its better fairness properties. Consider a difficult task for which only a few number of competent workers can predict the correct answer. A system needs competent workers for solving such a task. When the peer prediction payment rule is implemented, a competent worker may receive a payment that is only as much as the payment of an incompetent worker, which may discourage the competent worker from participating. When the system implements consensus prediction payment, the payment of a competent worker is likely to be higher than the payment of an incompetent worker, if the system can deduce the correct answer and has accurate worker models. Thus, the system implementing consensus prediction payments is more likely to attract high quality workers and discourage low quality workers, which results in higher efficiencies for the system and the task owner.

An advantage of the peer prediction and consensus prediction payment rules is that they can adapt to changing worker populations with updating worker models in real-time as they make new observations about workers. For example, a group of malicious workers may collude on a strategy to increase their payments in a consensus system. Although these workers may initially succeed, the system can update the worker models as it makes observations about these workers. When the worker models can model the behavior of these workers properly, these workers may start getting penalized for not reporting honestly to the system.

Incentivizing workers to report truthfully to a consensus system once they decide to participate in the system in one challenge. A consensus system may face additional challenges in real-world applications in terms of attracting workers. For example, the expected payment of a competent worker may be lower for a difficult task. The system may not be able to solve the task due to not being able to attract competent workers. Another challenge may arise if workers' expected payments vary depending on when they participate in the system. A worker may decide to wait to participate in the system which may reduce the efficiency of the system. An advantage of the payment rules that employ proper scoring rules is that the expected payment of a worker can be scaled to any desired value without degrading the incentive compatibility properties of these rules.

Thus, a consensus system can promote truthful reporting by implementing peer prediction and consensus prediction payments, under some strict common knowledge assumptions and the requirement that the system is able to accurately compute these payments. Satisfying these assumptions and requirements may be relatively difficult for a real-world system that desires to implement truth-promoting payment rules.

It is not realistic in many real-world settings to expect that workers of a system will have enough information about tasks and workers to accurately estimate prior probabilities on answers and the likelihood of worker reports. This situation violates the common knowledge assumptions. One simple way to relax these assumptions is building trust between the system and the workers (e.g., via transparency of predictive models). As long as workers trust the system to calculate peer prediction or consensus prediction payments correctly, it is the best response for workers to reveal their true inference about a correct answer.

It is generally assumed that a system has enough history to learn prior answer probabilities and worker report probabilities. This history needs to be collected from truthful workers so that the system can learn about the true inferences of workers, and these models can be used for payment calculations. At the same time, such history data needs to be collected from truthful workers, yet without an incentive-compatible system in place. A known two-step revelation approach may be used in which a participant reveals her belief before and after receiving a signal (experiencing a product or answering to a consensus task). The system uses the difference in these beliefs to infer the true report of the worker. The two-step revelation approach can be used with both the peer prediction and consensus prediction rules to promote truthful reporting when common knowledge assumptions do not hold. Having two-step revelation over beliefs clearly increases the reporting cost of a participant, but offers a viable approach to collect enough data about workers' inferences until the system is able to train accurate predictive models.

Common knowledge assumptions can be relaxed if trust between workers and the system is not assumed and the two-step revelation approach is too costly to implement. One reason the common knowledge assumptions does not hold is when the system does not have enough information about the task and workers, and thus cannot calculate payments accurately. Peer prediction and consensus prediction rules incentivize workers to collaborate with the system and to share information with the system to accurately calculate payments. Another reason is the noisy calculation of payments due to computational limitations and the noise in predictive models.

The incentive compatibility of consensus systems depends on whether payments can be computed accurately. Because payments are computed based on the predictions of predictive models, doing so not only requires having accurate models, but also having comprehensive set of evidences and features that can perfectly model a task and workers reporting for the task. If a system does not know some of the features that workers know, the common knowledge assumptions may not hold. For example, if a system cannot judge how difficult a task is, but a worker can, the worker may strategize to improve her payment by not reporting truthfully. The proposition below shows that when workers and the system have a channel to communicate, peer prediction and consensus prediction rules incentivize workers to communicate the difficulty of the task (or any other feature in f that the worker knows but the system does not) so that the common knowledge assumptions are satisfied and the system can accurately calculate payments.

Define two sets of features Fᵢ^{w} and Fᵢ^{s} such that Fᵢ=Fᵢ^{w}∪Fᵢ^{s}. The set of features that the system can infer correctly is Fᵢ^{s}. This set may include the general statistics about the worker population and the tasks. Fᵢ^{w} is the set of features that workers can infer correctly, but the system may not. This set may include the personal competency of worker i, whether the given task is relevant to the worker, and how difficult the task is for the worker. Define fᵢ^{s} as the true valuation of Fᵢ^{s}, fᵢ^{w} as the true valuation of Fᵢ^{w}, and f̅ᵢ^{w} as the system's estimation of the features in Fᵢ^{w}. Assume that Fᵢ^{w} is stochastically relevant for Cⱼ for any worker j conditional on fᵢ^{s} and any realization of Cᵢ (i.e., knowing the true value for these features help to better predict other workers' reports). If a system is implementing peer prediction rules, it is the equilibrium of the system for every worker i to report fᵢ^{w} was well as her true inference about the correct answer.

Another reason for the common knowledge assumptions not to hold is the fact that payment calculations can be noisy in real-world systems. As demonstrated for consensus tasks, the calculation of peer prediction and consensus prediction rules may require incorporating the predictions of multiple predictive models. Because these models need to be learnt, their predictions can be noisy. Moreover, approximately calculating consensus prediction rules may introduce another layer of noise in payment calculations. Having noise in payment calculations eliminates the incentive compatibility property of a system implementing these payments if there are workers that can notice this noise and has the computational power to strategize about what to report. Proper payments are hard for regular people to compute. The calculations require accurately estimating the way other workers report, without having statistics about prior behavior, and performing complex calculations on them. It is unrealistic to expect that workers can distinguish small differences in the expected utilities of different reporting strategies. Moreover, a worker that is strategic and aims at maximizing expected payment by not always being truthful, has a cost for being manipulative. For each possible task, the worker needs to calculate expected payments for different strategies and select the strategy that maximizes the expected payment.

Workers with these characteristics may be formally defined as ε-strategic agents. An ε-strategic agent is indifferent between strategies that differ less than ε≦0 in expected utilities and has cost ρₘ≦0 for strategizing about what to report. The characteristics of ε-strategic agents may be used to redefine incentive-compatibility. This probabilistic definition takes the possible limitations of human workers into account, and thus it is more realistic for real-world applications. This definition takes into account the expected utility of a worker for deviating from reporting truthfully.

Depending on the proper scoring rule used in calculating payments, and the magnitude of noise in predictive models and in sampling, the error in payments computed by the system may be bound, and consequently the maximum amount that workers can gain by deviating from reporting truthfully may be bound. For a given a consensus system and a consensus task, let λ_{f}≦0 be the likelihood that the expected gain of a worker for not reporting truthfully is higher than a constant value ε_{f}≦0. One incentive-compatibility definition reasons about the characteristics of ε-sensitive agents and also the error bounds on the system's calculation of proper payments. This definition extends the definition of ε-Bayesian-Nash incentive compatibility to consider ε-strategic agents

A property of basic payment rules is that their range of payments is naturally bounded. However, the range of payments computed with proper payment rules varies with respect to the proper scoring rule implemented as well as the task and workers reporting for the task. Normalizing these payments into any desired interval is useful for a system that wants to bound the minimum and maximum payments offered to a worker to manage the budget of a task owner and to ensure the happiness of workers. However doing so is not a trivial task since the value of a payment computed for a worker can be −∞ when the logarithmic scoring rule is used in calculations. A well-known property of proper scoring rules is that any positive affine transformation of a strictly proper scoring rule is also a strictly proper scoring rule. For any proper payment rule τ^{p}, proper scoring function S used in calculating τ^{p}, and a consensus task, it is possible to calculate the minimum and maximum payments that can be computed for the task. The minimum and maximum payments, Vₘᵢₙ and Vₘₐₓ respectively, can be computed by traversing all possible values that Rᵢ and R₋ᵢ can take. Since these minimum and maximum values are computed over all possible worker reports, they cannot be manipulated by workers.

$${V}_{min} = {min}_{{r}_{i} , {r}_{- i}} {τ}^{p} ( {r}_{i} , {r}_{- i} )$$

$${V}_{max} = {max}_{{r}_{i} , {r}_{- i}} {τ}^{p} ( {r}_{i} , {r}_{- i} )$$

For any value of rᵢ and rᵢ₋₁, τᵢⁿ, the normalized payment rule calculates payments in range [0; 1] as given below.

$${τ}_{i}^{n} ( {r}_{i} , {r}_{- i} ) = \frac{{τ}^{p} ( {r}_{i} , {r}_{- i} ) - {V}_{min}}{{V}_{max} - {V}_{min}}$$

This normalization rule is undefined for two special cases, namely when Vₘᵢₙ=Vₘₐₓ and when Vₘᵢₙ=−∞. The first case violates a fundamental assumption of applying proper payments to crowdsourcing tasks that is any worker report is stochastically relevant to the signal used in evaluation. Thus, when stochastic relevance holds, this case cannot be realized. The second case is realized only if the logarithmic scoring rule is implemented in payment calculations, and there exists an instantiation of a worker report and a signal such that the likelihood of observing the signal given the worker report is 0. Given that the likelihood of observing this instantiation is zero, excluding this report and signal combination from payment calculations has no effect since this combination is impossible to occur.

A crowdsourcing system needs to ensure the happiness of its worker population as well as task owners. To ensure worker happiness, an important property for the system to have is individual rationality. The system needs to ensure that no worker is worse off by participating in the system. Scaling payments computed with proper payment rules can ensure individual rationality of workers without degrading the incentive-compatibility properties of these payment rules.

Let pₚⁱ be worker i's cost for participating at the consensus system for solving a consensus task, and pᵣⁱ be the worker's cost for making inference about the task. Let EUᵢ^{C}^{ᵢ} be the expected payment of worker i in the equilibrium when all workers reveal their true inferences about the correct answer and E [symbol] be the expected payments of worker i when the worker does not perform inference but follows a fixed strategy sᵢεAΩR for reporting. Assume that learning about the features of a task is a part of the inference process, thus workers make a decision about collecting more information about a task (i.e., by performing inference) without knowing about the task. Calculate EUᵢ^{C}^{ᵢ} and E [symbol] as an expectation of the features of a task, given that F is a random variable representing the features of a given task.

$${EU}_{i}^{{C}_{i}} = {\sum }_{f} Pr ( F = f ) {\sum }_{{c}_{i} ∈ {Ω}_{R}} {Pr}_{f} ( {C}_{i} = {c}_{i} ) {\sum }_{{c}_{- i} ∈ {Ω}_{R}^{\vert {f}_{- i} \vert}} Pr ( {C}_{- i} = {c}_{- i} \vert {C}_{i} = {c}_{i} ) {τ}_{i}^{n} ( {c}_{i} , {c}_{- i} )$$

$${EU}_{i}^{{C}_{i}} = {max}_{{s}_{i} ∈ {Ω}_{R}} {\sum }_{f} Pr ( F = f ) {\sum }_{{c}_{- i} ∈ {Ω}_{R}^{\vert {f}_{- i} \vert}} {Pr}_{f} ( {C}_{- i} = {c}_{- i} \vert F = f ) {τ}_{i}^{n} ( {s}_{i} , {c}_{- i} )$$

Given that the expected normalized payments of a worker may be estimated when she does and does not perform inference, the appropriate affine transformation may be calculated for ensuring individual rationality.

### Example Operating Environment

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 4 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 4 thus illustrates an example of a suitable computing system environment 400 in which one or aspects of the embodiments described herein can be implemented, although as made clear above, the computing system environment 400 is only one example of a suitable computing environment and is not intended to suggest any limitation as to scope of use or functionality. In addition, the computing system environment 400 is not intended to be interpreted as having any dependency relating to any one or combination of components illustrated in the example computing system environment 400.

With reference to FIG. 4, an example remote device for implementing one or more embodiments includes a general purpose computing device in the form of a computer 410. Components of computer 410 may include, but are not limited to, a processing unit 420, a system memory 430, and a system bus 422 that couples various system components including the system memory to the processing unit 420.

Computer 410 typically includes a variety of computer readable media and can be any available media that can be accessed by computer 410. The system memory 430 may include computer storage media in the form of volatile and/or nonvolatile memory such as read only memory (ROM) and/or random access memory (RAM). By way of example, and not limitation, system memory 430 may also include an operating system, application programs, other program modules, and program data.

A user can enter commands and information into the computer 410 through input devices 440. A monitor or other type of display device is also connected to the system bus 422 via an interface, such as output interface 450. In addition to a monitor, computers can also include other peripheral output devices such as speakers and a printer, which may be connected through output interface 450.

The computer 410 may operate in a networked or distributed environment using logical connections to one or more other remote computers, such as remote computer 470. The remote computer 470 may be a personal computer, a server, a router, a network PC, a peer device or other common network node, or any other remote media consumption or transmission device, and may include any or all of the elements described above relative to the computer 410. The logical connections depicted in FIG. 4 include a network 472, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. A method implemented at least in part on at least one processor, comprising, receiving a task including task data comprising a budget, and computing a number of workers needed to perform the task without exceeding the budget, including by predicting future contributions using one or more answer models to estimate the number of workers.

2. The method of claim of claim 1 wherein computing the number of workers further comprises using one or more vote models that are based upon existing data.

3. The method of claim of claim 1 further comprising, adaptively learning the one or more answer models.

4. The method of claim 1 wherein receiving the task, including task data, further comprises receiving a task deadline.

5. The method of claim 1 wherein the task comprises a consensus task, and wherein receiving the task, including task data, further comprises receiving a value corresponding to when a consensus vote reaches an acceptable confidence level.

6. The method of claim 1 further comprising, computing a payment for each worker.
